(19) United States
(12) Patent Application Publication
(10) Pub. No.: US 2010/0007869 A1
(43) Pub. Date: Jan. 14, 2010

(54) Reticle Handler

(75) Inventors: Xiao Min Xu, Shanghai (CN); Ling Hwee Goh, Shanghai (CN); Chih Jui Chin, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Semiconductor Manufacturing International (Shanghai) Corporation, Shanghai (CN)

(21) Appl. No.: 12/238,575

(22) Filed: Sep. 26, 2008

(30) Foreign Application Priority Data
Jul. 8, 2008 (CN) 200810040365.1

(51) Int. Cl. G03B 27/62

(52) U.S. Cl. 355/75

(57) ABSTRACT

The present invention provides an apparatus and method for handling a reticle during manufacturing processes of semiconductor devices in the fabrication line. The apparatus includes a holder for the reticle, the holder is configured to securely hold the reticle and a level indicator attached to and operative with the holder to indicate leveling condition of the holder. The apparatus further includes a shaft connected to the holder for holding and a switch connected to the shaft. The method includes providing a reticle and clamping the reticle with a reticle holder including a switch and a leveling indicator operative with the holder to indicate leveling condition of the holder. The method further includes loading the reticle into a reticle pod while maintaining the leveling condition of the holder.

### CROSS-REFERENCES TO RELATED APPLICATIONS

This application claims priority to Chinese Application No. 200810040365.1, filed Jul. 8, 2008, commonly assigned, and incorporated herein by reference for all purposes.

### BACKGROUND OF THE INVENTION

The present invention relates to apparatus and method for manufacturing semiconductor devices. More particularly, the present invention provides a reticle handler for preventing reticles from being damaged or scratched during the manual handling of the reticles in the fabrication line.

In photolithography, reticles or masks are comprised of a patterned opaque coating such as chrome on a transparent substrate and are used to manufacture integrated circuits for semiconductor devices or other devices requiring the formation of small features on a substrate. A set of photomasks, each defining a patterned layer in integrated circuit fabrication, is provided into a photolithography stepper or scanner and individually selected for exposure. In photolithography for the mass production of integrated circuit devices, the photomask is also referred to as photoreticle or reticle. As used in steppers and scanners, the reticle contains one layer of the chip. This is projected and shrunk by four or five times onto the wafer surface. To achieve complete wafer coverage, the wafer is repeatedly stepped from position to position under the optical column until full exposure is achieved.

Reticles are usually fabricated by forming a pattern in a photoresist film on an underlying opaque coating on a substrate. The pattern in the photoresist is transferred through the underlying opaque coating by an etch step. The photoresist serves as an etch mask. High quality reticles are valuable because of the time and expense needed to produce them. The time required to build a reticle can take up to two weeks and the cost can easily be $20,000 or more because expensive electron beam tools are used to form patterns and expensive focused ion beam tools may be employed to repair defects.

During the manufacture of integrated circuits, reticles must be protected from damage or particles that might adhere to its surface. A covering consisting of a thin film called a pellicle is mounted on a frame or spacer to connect the pellicle to a reticle. Dust particles are kept off the reticle by collecting on the pellicle which is typically a thin film of highly transparent material such as nitrocellulose. Any particle that collects on the pellicle does not affect the aerial image of the pattern transmitted from the reticle onto the photoresist film on a device substrate. Since the particle is not in the focal plane on the reticle surface, its image is not reproduced on the photoresist film. Otherwise, any particle that collects on a clear quartz region on a reticle is reproduced as a defect in the photoresist film and can eventually degrade the performance of the fabricated device.

Occasionally, pellicles are torn or scratched while being handling by a handler in the fabrication line and must be replaced. The process of producing and repairing the reticle is expensive. Since reticles are fragile, they are protected from ESD hazards or other damages by carrying them in a specially designed reticle pod or support. When reticles are manually loaded into pods or onto supports with a tilt angle, pellicle may touch the upper, horizontal section of the support in the back. Since tilting beyond a certain angle results in damaging the pellicle when the reticle is loaded, leveling of the reticle is required. From the above, it is seen that an improved reticle handler for processing semiconductor devices is desired.

### BRIEF SUMMARY OF THE INVENTION

The present invention relates to apparatus and method for manufacturing semiconductor devices. More particularly, the present invention provides a reticle handler for preventing reticles from being damaged or scratched during the manual handling of the reticles in the fabrication line.

In a specific embodiment of the present invention, an apparatus for handling reticles is provided. The apparatus includes a holder for the reticles and a level indicator attached to and operative with the holder to indicate leveling condition of the holder. The apparatus further includes a shaft connected to the holder and a switch connected to the shaft.

In another specific embodiment of the present invention, a method for handling a reticle is provided. The method includes providing a reticle and clamping the reticle with a reticle holder including a switch and a leveling indicator operative with the holder to indicate leveling condition of the holder. The method further includes loading the reticle into a reticle pod while maintaining the leveling condition of the holder.

Many benefits are achieved by way of the present invention over conventional reticle handlers. For example, operators using the present reticle handler may prevent pellicle damage or scratch during handling of the reticles. Therefore, safe handlings of valuable reticles are achieved and operators' skill is not that critical. Depending upon the embodiment, one or more of these benefits may be achieved. These and other benefits will be described in more throughout the present specification and more particularly below.

Various additional advantages of the present invention can be more fully appreciated with reference to the detailed description and accompanying drawings that follow.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a simplified plan view diagram of a reticle on which pellicle is attached;

FIG. 2A is a simplified top view diagram of a pellicle, upper part of which is damaged during manual loading onto supports by the conventional reticle handler;

FIG. 2B is a simplified cross-sectional diagram along the line A-A′ in FIG. 2 illustrating reticle 200 placed on the support 204;

FIG. 3 is a simplified cross-sectional view of a reticle handler according to an embodiment of the present invention;

FIG. 4 is a simplified cross-sectional view of a reticle handler as shown in FIG. 3 with reticle unloaded.

### DETAILED DESCRIPTION OF THE INVENTION

The present invention generally relates to integrated circuits and their processing for the manufacture of semiconductor devices. More particularly, the present invention provides an improved reticle handler for preventing reticles from being damaged or scratched during the manual handling of the reticles in the fabrication line. Merely by way of example, the invention has been applied to a reticle handler for the manufacture of integrated circuits, but it would be recognized that the invention has a much broader range of applicability.

It is also understood that the examples and embodiments described herein are for illustrative purposes only and that various modifications or changes in light thereof will be suggested to persons skilled in the art and are to be included within the spirit and purview of this application and scope of the appended claims.

Exemplary embodiments of the invention are more fully described in detail with reference to the accompanied drawings. The invention may be embodied in many different forms and should not be construed as being limited to the exemplary embodiments set forth herein. Rather, these exemplary embodiments are provided so that this disclosure is thorough and complete, and to convey the concepts of the invention to those skilled in the art.

Embodiments of the present invention provide, among other things, an improved reticle handler for inserting a reticle into a pod without damaging pellicle.

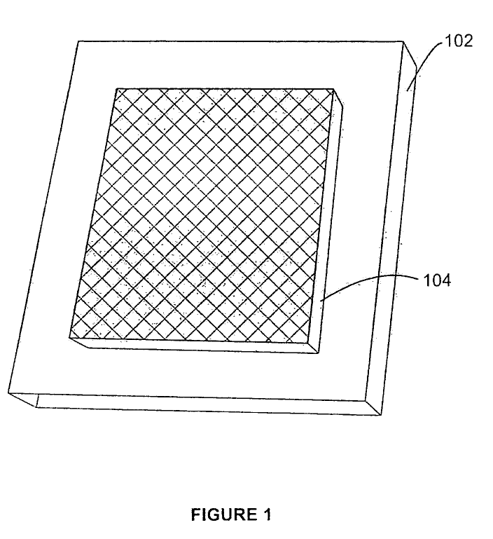

FIG. 1 is a simplified plan view diagram of a reticle 102 on which a pellicle 104 is attached. It is well known that during the manufacture of semiconductor devices the goal is to achieve defect free exposures of circuit patterns. As integrated circuits evolved from small scale integration to very large scale integration the need for ultra clean manufacturing space became increasingly critical. As an example, a single airborne particle landing on the photomask surface during exposure can ruin the circuit exposed on the wafer below it.

To help solve this problem, the photolithographic industry developed pellicles to intercept particulates and protect the surfaces of photomasks against all forms of contamination. Pellicles include a thin, transparent membrane stretched across a frame. The frame holds the membrane in tension and keeps it away from the mask surface by the thickness of the frame. An adhesive is used to bond the frame to a surface of the photomask.

A pellicle has a dual role in improving the accuracy of the image projected onto a wafer. First, a pellicle serves to protect the reticle from direct contact with particulate contamination. As discussed above, particles that settle on the reticle can produce image distortion, so they must be removed. However, removal of particles from the reticle can cause damage to the reticle because such removal may involve direct contact with the reticle. When a pellicle is used, particles will settle on the pellicle rather than the reticle. Thus, it is the pellicle that must be cleaned. Cleaning the pellicle rather than the reticle poses fewer dangers to the integrity of the reticle since the reticle is protected during this cleaning by the pellicle itself.

The second role played by a pellicle is related to the standoff of the pellicle. During exposure, the focal plane corresponds to the location of the image printed on the reticle. By including a pellicle, any particles in the system will settle on the pellicle rather than the reticle. By virtue of the thickness of the pellicle, and thus the distance between the surface of the pellicle and the patterned surface of the reticle, these particles will not be in the focal plane. Since the pellicle lifts the particles out of the focal plane, the probability that the image projected onto the substrate will include these particles is greatly reduced.

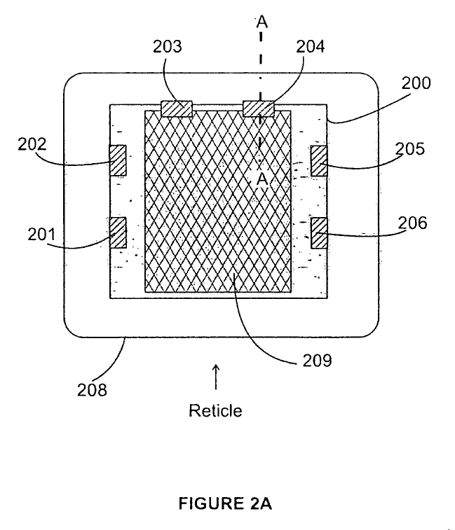

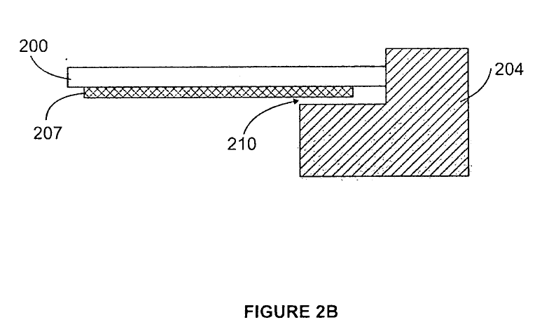

FIG. 2A is a simplified top view diagram of a reticle 200 placed on the reticle supports 201-206 of the reticle pod 208. Occasionally, pellicles become torn or damaged during handling. This may happen particularly when reticles are inserted into reticle holders or placed on supports with a tilt angle as illustrated in FIGS. 2A and 2B. Reticle supports 201-206 are in contact with the reticle 200 as the reticle is loaded. The upper parts of the pellicle 207 abutting on supports 203 and 204 are subject to damage during manual loading into the reticle pod 208 by using the conventional reticle handler.

FIG. 2B is a simplified cross-sectional diagram along the line A-A′ in FIG. 2A, showing the reticle 200 as placed on the support 304. FIG. 2B illustrates how the lower surface of the pellicle 207 can touch the upper, horizontal surface 210 of the support 204 when the reticle 200 is inserted into the reticle pod 208. When the reticle 200 is placed on the supports 201-206, a gap between the pellicle 207 and the surface of the support 204 may exist due to a height difference among the supports 201-206. Under this situation, if the reticle 200 is inserted into the reticle pod 208 with a tilt angle, pellicle 207 may touch the upper, horizontal surface of the support 204. Thus, tilting beyond a certain angle may result in damage to the pellicle when it is inserted. This angle generally depends on the height difference among supports 201-206. However, any left to right tilt creates no such problem because the supports 201-202 and 205-206 would touch the quartz only and not the pellicle as shown in FIG. 2A.

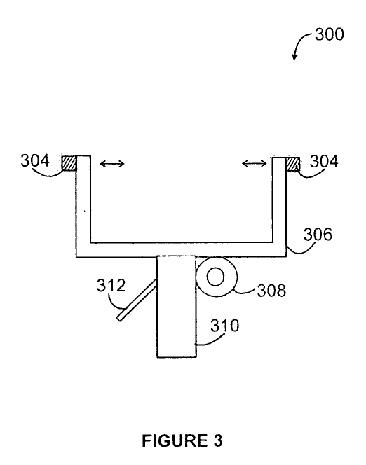

FIG. 3 is a simplified cross-sectional view of a reticle handler 300. The reticle handler 300 includes a shaft 310, a U-shaped holder 306 having a pair of clamp members 304, a switch 312, and a bubble leveling indicator 308 attached either to the holder 306 or the shaft 310. A holder 306 is U-shaped with an open top end and a pair of clamp members 304 positioned at its ends. The clamp members 304 move inwardly to hold or clamp the reticle when switch 312 is turned “ON” (locked). The clamp members 304 move outwardly to release and place the reticle on the supports when the switch is turned “OFF”.

A level indicator 306 can be attached to the holder 306 or to the body of the shaft 310. A bubble level indicator or any other types can be attached for precise leveling of the holder 306. As explained above, a precise alignment and leveling of the holder is necessary to prevent pellicle from being damaged when the reticle is loaded into or unloaded out of the reticle pod. The level indicator 308 may include a cylinder body which has a hemispherical bottom, a top end that is formed with a fluid cavity and a window that covers the fluid cavity. The window may have a leveling marker formed thereon. The fluid cavity contains a volume of liquid therein. The liquid forms a positioning bubble beneath the window. The reticle handler 300 may be adjustably inclined during succeeding use so as to align the positioning bubble with the leveling marker. One of ordinary skill in the art would recognize many variations, alternatives, and modifications.

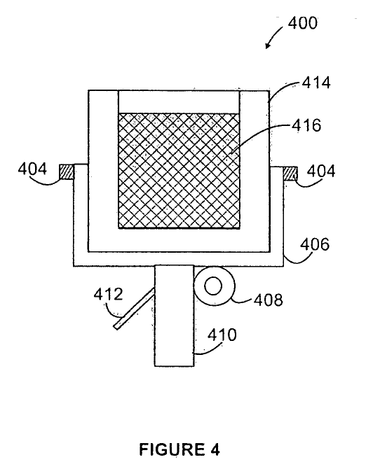

FIG. 4 is a simplified cross-sectional view of a reticle handler as shown in FIG. 3 with reticle loaded. Reticle 414 is securely clamped by the holder 406 and the clamp members 404 of the reticle handler 400. The reticle 414 can be safely loaded into or unloaded from the reticle pod or stepper systems by maintaining the leveling condition of the reticle handler using the leveling indicator 408.

These diagrams are merely examples, which should not unduly limit the scope of the claims. One of ordinary skill in the art would recognize many variations, alternatives, and modifications. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. Apparatus for handling a reticle, the apparatus comprising:
a holder to hold the reticle;
a leveling indicator coupled to the holder to indicate leveling condition of the holder;
a shaft connected to the holder enable a person to hold the apparatus; and
a switch connected to the shaft and adapted to control the holder to hold the reticle.

2. The apparatus of claim 1 wherein the holder is U-shaped.

3. The apparatus of claim 1 wherein the holder has a pair of clamp members moving inwardly to clamp the reticle.

4. The apparatus of claim 1 wherein the leveling indicator is a bubble leveling indicator.

5. The apparatus of claim 1 wherein the switch is configured to lock or unlock the holder.

6. A method for handling a reticle, the method comprising:
clamping a reticle with a holder including a switch and a leveling indicator operative with the holder to indicate leveling condition of the holder; and
loading the reticle into a reticle pod while maintaining the leveling condition of the holder by using the leveling indicator.

7. The method of claim 6 wherein a pellicle is provided over the reticle to protect the reticle.

8. The method of claim 6 wherein the holder is U-shaped.

9. The method of claim 6 wherein the leveling indicator is a bubble leveling indicator.

10. The method of claim 6 wherein the switch is turned on to lock the reticle holder.
